(19) United States
(12) Patent Application Publication
(10) Pub. No.: US 2002/0172339 A1
(43) Pub. Date: Nov. 21, 2002

(54) Method for providing sequenced communications within a group

(76) Inventors: Carroll W. Creswell, Basking Ridge, NJ (US); Ronald Sherman, Livingston, NJ (US)

Correspondence Address: Samuel H. Dworetsky, AT&T CORP., P.O. Box 4110, Middletown, NJ, 07748-4110, US

(21) Appl. No.: 09/861,742

(22) Filed: May 21, 2001

(51) Int. Cl. H04M 3/42

(52) U.S. Cl. 379/201.01; 379/202.01; 379/207.02

(57) ABSTRACT

A system and method for providing sequenced communications to members of a defined telecommunication group is provided. The system is accessible to a communicating user connected to a telecommunication network and includes an interface for providing the communicating user with the ability to initiate a sequence of separate communications to each of a plurality of members in the defined group, without the communicating user having to initiate separate communication sessions for each member. The system may permit communications to be made using one or more telecommunication modes such as telephone calls, instant messages, e-mail messages, or voice-mail messages.

### CROSS-REFERENCE TO RELATED APPLICATIONS

This application is related to co-pending U.S. application Serial No. ______, entitled “System For Providing Sequenced Communications Within A Group,” filed concurrently herewith and commonly assigned.

### FIELD OF INVENTION

The present invention relates to the field of telecommunications and more particularly to a system and method for allowing a user to selectively communicate with members of a defined group over a communication network, such as a data or voice network.

### BACKGROUND OF THE INVENTION

Telecommunication systems (e.g., applications, programs, or devices) typically have the ability to store contact information, such as telephone numbers or e-mail addresses, for parties that a user often communicates with. For example, stored contact information may be accessible through a designated button (e.g., a programmed memory button on a telephone), by typing at least part of a name or address (e.g., the characters of a stored e-mail address), or by a menu selection step (e.g., scrolling through a list of stored e-mail addresses).

In some systems, such as email and voice mail systems, the stored contact information of parties may be arranged in groups, so that a user can broadcast or distribute a message to all members in a group simultaneously. For example, a member of a social or recreational club, such as a sports team or church group, may form a group containing all of the members, so that they can be notified of an upcoming meeting or get-together. Similarly, a member of a business or professional committee may create a voice mail distribution group including other members in the committee, so that each member can be sent a voice message regarding the committee's activities. In such prior art telecommunication systems, where a user desires to communicate with members of a specific group, the user communicates with all members of the group at the same time. However, in many instances, a user may desire or prefer to contact only some of the members of a group and/or to customize the content of the communication to each group member. Although the user may initiate a separate communication to each desired individual group member, this is generally a time-consuming, cumbersome, and inflexible approach.

As a result, there is a need for a telecommunication system that offers a user a more flexible and efficient approach to communicate with different members of a defined telecommunication group.

### SUMMARY OF THE INVENTION

In one aspect, the present invention relates to a system for facilitating sequenced communications to members of a defined group. The system comprises an application interface implemented in software and accessible to a communicating user connected to a telecommunication network. The interface enables the communicating user to initiate a single communication session in which the communicating user is sequentially stepped through separate communications to each of a plurality of members in the defined group, without the communicating user having to initiate separate communication sessions for each member. Possible telecommunication modes include telephone calls (both conventional and voice-over-IP), video conference calls, instant messages, e-mail messages, and voicemail messages.

The system may comprise a database for storing telecommunication address information relating to one or more telecommunication modes for each group member. Therefore, the interface may provide the communicating user with the ability to select the telecommunication mode for the sequence of separate communications. In one embodiment, the interface is displayed on a screen of a device of the communicating user, and the communicating user may interact with the interface, e.g., initiate the sequential communication session, by selecting an icon displayed on the screen of the device. In another embodiment, the interface is audio-based and the communicating user can interact within the system using audio commands, such as spoken or touch tone commands.

The interface provides the communicating user with the ability to enter an instruction to proceed to the next communication in the sequence of separate communications. Alternatively, the system may automatically proceed to the next communication in the sequence of separate communications once a prior communication in that sequence has terminated. Also preferably, the interface provides the communicating user with the ability to enter an instruction to skip the next communication in the sequence of separate communications.

The separate communications may be made in real time (e.g., telephone calls or instant messages) or not in real-time (e.g., e-mail or voicemail messages). For non-real time communications in particular, the system may provide the communicating user with the ability to create common content for inclusion in each of the separate communications.

In another aspect, the system may be run on an application server accessible to a communicating user over a telecommunication network. The server comprises software for providing the interface to the communicating user and for effecting communication between the communicating user and the members within the group. The server may access the database storing telecommunication address information for each of a plurality of members in a defined group.

### BRIEF DESCRIPTION OF THE DRAWINGS

The present invention will be better understood and more readily apparent when considered in conjunction with the following detailed description and accompanying drawings which illustrate, by way of example, embodiments of the invention and in which:

FIG. 1 is a block diagram overview of a suitable network architecture for implementing a system for sequentially communicating with members in a group in accordance with an embodiment of the present invention;

FIG. 2 illustrates a possible data field structure for a group stored in a database of a sequential communication system;

FIG. 3 illustrates a possible directory format for groups and sub-groups associated with a user account in a sequential communication system;

FIG. 4 is an exemplary group connection screen interface that may be displayed on a screen-based device of a user accessing a sequential communication system;

FIG. 5 is a flow chart illustrating a preferred method of operation of a sequential communication system in the case of communications made in real-time; and

FIG. 6 is a flow chart illustrating a preferred method of operation of the sequential communication system in the case of non-real-time communications.

### DETAILED DESCRIPTION

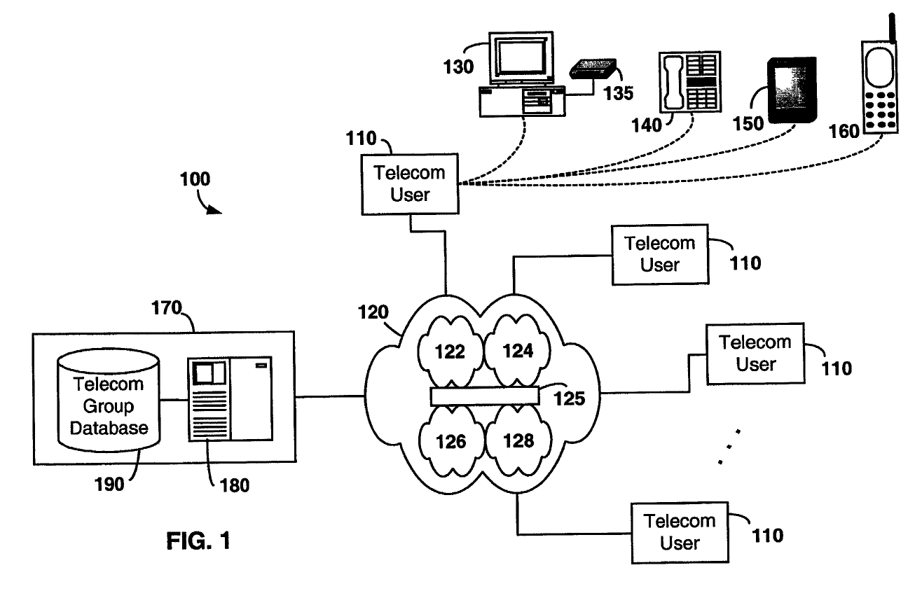

FIG. 1 is a block diagram overview of a network architecture 100 in which the system of the present invention may be implemented to provide a telecommunication customer or user with sequenced telecommunication connections to other users within a defined group. The architecture 100 includes a plurality of telecommunication users 110 who communicate with one another over a telecommunication network 120 typically by voice (e.g., over a standard telephone connection, over a voice-over-IP connection, by voice attachment or file exchange, or by voice mail messaging) and/or data (e.g., by computer network e-mail or instant messaging). Telecommunication network 120 may, for example, comprise one or more of a private network (e.g., an enterprise network) 122, the Internet 124, the public switched telephone network (PSTN) 126, and a wireless/paging network 128. Telecommunication network 120 may also comprise other types of information networks, including a local telephone network (such as a private branch exchange or a Centrex service) or a cable network. Where telecommunication network 120 comprises different types of networks, suitable gateways 125 may be used, as necessary. For instance, where a user connected to a data network (e.g., the Internet) communicates with a user connected to a voice network (e.g., the PSTN), a voice-over-IP gateway may be used between the data and voice networks.

As illustrated in FIG. 1, to communicate over network 120, each user 110 may be equipped with a computer system 130 having a communication interface 135 (e.g., a modem or Ethernet card) and also possibly a speaker and microphone (not shown), a telephone 140, a network-enabled personal digital assistant 150, and/or a wireless telephone 160. More generally, a user may communicate with other users using any suitable device or customer premise equipment including video/screen telephones, network-enabled portable computers (e.g., having wireless modems), pagers, facsimile machines, set-top cable boxes, satellite transmitter/receiver units, and so on. A user 110 may also communicate using more than one device and/or over more than one type of communication network (e.g., data and voice networks). Thus, for example, a wireless telephone user connected to a wireless telephone communication network, a computer user having a voice-over-IP-enabled connection to the Internet, and a conventional telephone user may each communicate with one another by voice.

In known manner, each user is assigned (typically by a telecommunication service provider) at least one user-specific address or identifier that is used to identify the user in communication network 120. These identifiers may include a telephone number (for business, wireless, residential, paging, etc.), a telephone extension, an e-mail address, or a local/global computer network address such as an Internet Protocol (IP) address. At least some of users 110 are organized into telecommunication groups, for example, in electronic directories or address books. The groups may be formed on a system-wide basis, or alternatively each user may define groups specific to that user.

In the preferred embodiment of FIG. 1, system 100 includes a sequential communication system 170 having an application server 180 and a database 190 that stores contact or connection information relevant to groups of telecommunication users. In the illustrated embodiment, sequential communication system 170 comprises software running on server 180 that provides a system user interface to telecommunication users 110. The software running on server 180 also includes a communication interface module for effecting communications between a particular communicating user accessing the system and other users 110 within a group. As noted, the communication interface module may enable conventional telephone, voice-over-IP, instant messaging, e-mail, and/or voice mail message communication.

Depending on the type of telecommunication service and the nature of network 120, sequential communication system 170 may be a subsystem or part of a telephone service provider system, Internet service provider system, or other telecommunication service system. More generally, sequential communication system 170 may be located inside and/or outside of telecommunication network 120. For example, system 170 may be directly connected to a local telephone service provider's switch at a central office, or system 170 may be placed in an IP data network. System 170 may also comprise multiple application servers 180 and/or databases 190 at different locations. In an alternate embodiment, e.g., in the case of e-mail communications, the sequential communication system may be implemented as an application program that runs on the computer system 130 of a communicating user.

In accordance with the present invention, system 170 includes software (e.g., running on application server 180 in FIG. 1) for providing a telecommunication user 110 connected to network 120 with an interface for accessing sequential communication system 170. Access to the interface may be accomplished in a variety of manners such as by entering a designated uniform resource location address (URL) on a Web-enabled device, dialing a designated telephone number, or running a local application program. To access system 170, users 110 may be required to enter a log-in name or other identifier and/or a password. The interface is preferably screen-based or voice-based. Once accessed, sequential communication system 170 provides a user with the ability to provide an instruction to initiate a sequence of telecommunication communications so that the user can step through a list of users in a group, one at a time, under the communicating user's control and without having to initiate separate communication sessions with each group member. The sequenced communications may involve real-time connections to each user or the non-real-time recording of message content for each user and subsequent transmission to the user.

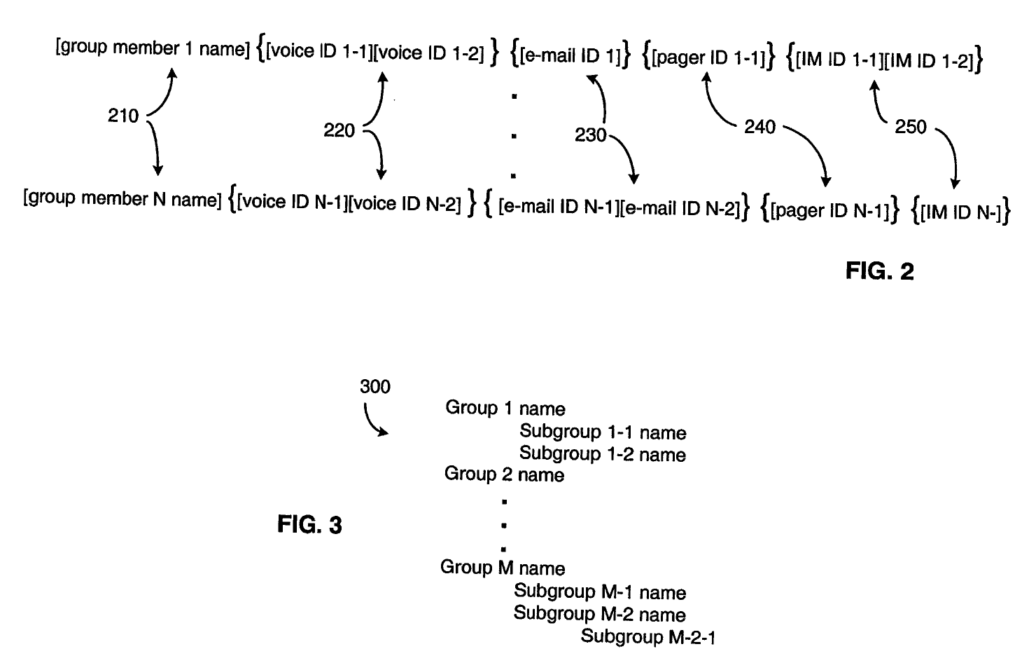

In an embodiment of the present invention, a user 110 can create a telecommunication group when accessing system 170, by selecting a group name or identifier, identifying the members of the group, any preferred ordering of those members, and the addresses or identifiers that may be used to connect or communicate with the group members. A group stored in database 190 may, for instance, have the data field structure illustrated in FIG. 2. In FIG. 2, for each of a plurality of members 1-N, information is stored in a member name field 210, a voice ID/address field 220, an email ID/address field 230, a pager ID/address field 240, and an instant messaging (IM) ID/address field 250. Generally, the data stored for each group member includes a member name field and at least one address field. Where members have several address fields, the communicating user can select a desired manner (e.g., telephone or e-mail) for communicating with group members. Also, as shown in FIG. 2, a member may have more than one entry in an ID/address field so that alternative addresses can be used at the option of a communicating user. For example, group member 1 has two voice ID addresses and two instant messaging ID addresses. In this case, the first address in a field is preferably used as a default address for communication.

When creating a group, a user is preferably able to specify which users can access and make sequential communications to members in the group. For example, a group-creating user may specify that only the user who created the group, certain specific users (e.g., certain members of the group), or any member of the group can make sequential communications to members in the group. For this purpose, system 170 may establish system accounts on an individual or organizational basis, with each account having one or more groups to select from. Groups in an account may be arranged in a directory format 300, as illustrated in FIG. 3. As shown, sub-groups may be created for each group, and sub-groups may, in turn, have further sub-groups. Each group and subgroup is identified by a name or other identifier, and a user 110 may select a particular group or sub-group by browsing through the directory or entering the group (or subgroup) identifier.

As indicated, a telecommunication user 110 accessing system 170 (e.g., on application server 180) may sequentially make voice-based communications or screen text-based communications to members of a group. Other modes of communication, such as video conferencing, may also be employed. These communications may be made as real-time connections (such as conventional telephone calls, voice-over-IP telephone calls, or instant messages), or the communications may be non-real-time in that the message content is entered or recorded and subsequently sent (such as e-mail, paging, or voice mail messaging).

In one embodiment of the present invention, sequential communication system 170 provides users 110 with a group connection screen interface, such as a World Wide Web (“Web”) or Intranet page, that a communicating user can access and interact with using a computer, PDA, web-enabled telephone or other device capable of displaying information. In another embodiment, the interface is voice-based and communicating users may access system 170 using a telephone (or telephone-enabled) device and interact therewith using spoken, touch tone, or other audio commands. Other interfaces may also be used—for example, a display interface that reacts to voice commands.

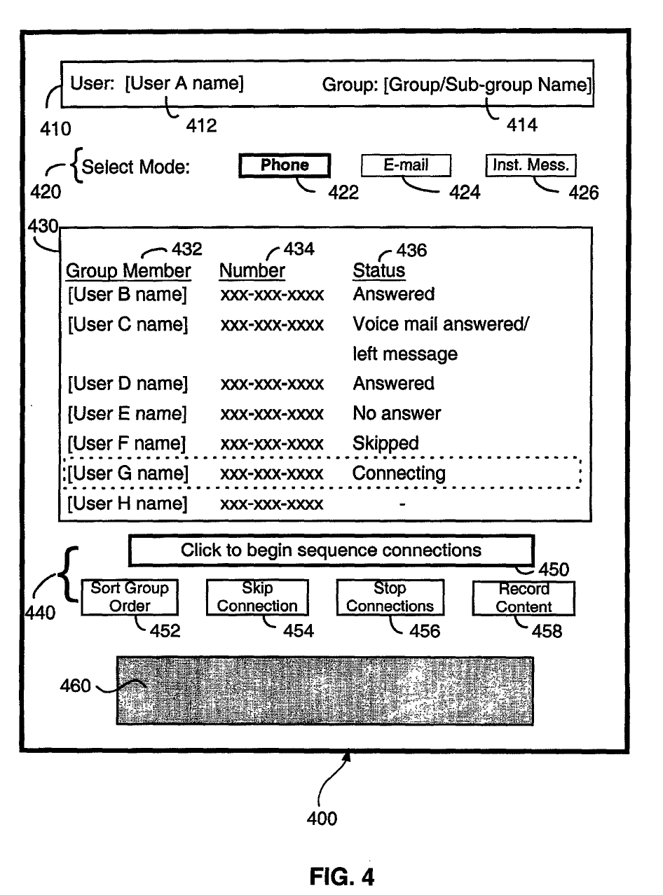

FIG. 4 shows an exemplary group connection screen interface 400 that may be displayed on a computer or other device of a user accessing sequential communication system 170. Interface 400 includes a header section 410, a telecommunication mode section 420, a group directory section 430, a command section 440, and an announcement section 460. Header section 410 may include the name of the user accessing the system in a field 412 (i.e., the communicating user) and the name of the group or sub-group selected by the user in a field 414. Header section 410 may also include a field (not shown) identifying the system 170 account to which the user is logged in, if appropriate. Where the selected group permits contacting group members by different telecommunication modes, telecommunication mode section 420 may be used to display the active telecommunication mode and permit switching between modes. In the illustrated interface 400, buttons 422, 424, and 426 are provided for a telephone mode, an e-mail mode, and an instant messaging mode respectively. In FIG. 4, the telephone mode (button 422) is shown as being active.

Section 430 of interface 400 lists the members of the group that the communicating user accessing system 170 wishes to contact. In the illustrated embodiment, for each member in the group, section 430 includes a group member name field 432, a communication mode address (in this case, telephone number) field 434, and a communication status field 436. If the communicating user accessing system 170 is included in a group at the time that the members of that group are being established, that user is not listed in section 430 (since the communicating user will generally not wish to contact himself or herself). Command section 440 comprises a button or icon 450 that allows the communicating user to instruct system 170 to begin a series of telecommunication communications to the users in the group. Section 440 may also include other buttons such as a sort group order button 452 that allows the order of group members (and the order in which they are contacted) to be changed and a skip connection button 454 that allows a user to skip a connection to a particular group member during the sequenced telecommunications. A button 456 for stopping all connections and ending the sequential communication session is also provided, as is a button 458 for recording content that a communicating user may wish to make common for all group members (for non-real-time communications). Announcement section 460 is used by sequential communication system 170 to display desired announcements to a communicating user before, during, and after the sequential communication session.

Sequential communication system 170 may also use a voice-based interface in which, for example, a communicating user dials a specific system access telephone number using a telephone, is presented with menu options, and enters spoken (i.e., voice-recognized) or touch tone commands to interact with the system. The access telephone number may be specific to a group or a system account for a number of groups. Alternatively, a special prefix code (e.g., * followed by a two-digit number) may be entered before a dialed number to access system 170. Once the system 170 interface is accessed, a voice or touch-tone command may be entered by the communicating user to begin a series of telecommunication connections to the users in the group. A telephone voice interface is described, for example, in U.S. Pat. No. 5,487,111 to Slusky, the contents of which are incorporated herein by reference.

More generally, and as will be appreciated by one of ordinary skill in the art, there are various possibilities with respect to where server 180 of system 170 is located in a communication network, how a user may access system 170, and how system 170 may interface with the communicating user. Typically, such details of the implementation of the present invention will vary depending on the particulars of an application and its design.

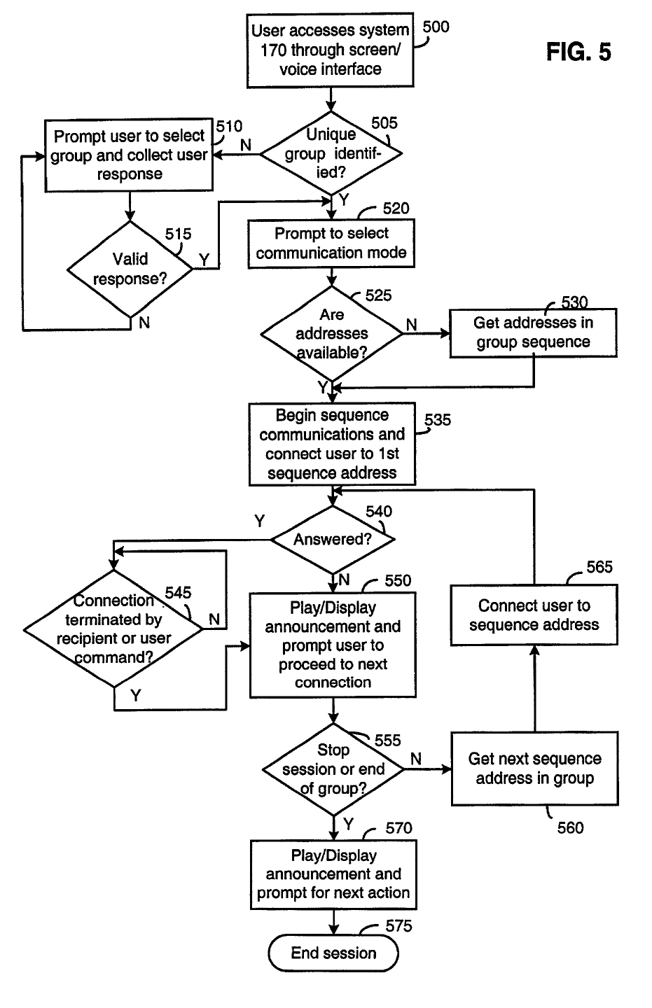

FIG. 5 is a flow chart illustrating a preferred method of operation of sequential communication system 170 in the case of communications that are being made in real-time, such as instant messages or conventional and voice-over-IP telephone calls. Referring to FIG. 5, a communicating user accesses system 170 at step 500 through, for example, a screen or voice interface. Step 505 determines whether such access identifies a unique group as would be the case, for example, if the account accessed by the communicating user has set up only one group. If not, at step 510, system 170 prompts the communicating user to select a group (e.g., by entering a group name or selecting a group from a directory). If the response from the user is valid, as determined at step 515, system 170 ensures that a unique group has been specified. Otherwise, the user is re-prompted to select a group up to some set limit; and if this limit is exceeded, system 170 may display an error message. Once a unique group has been identified, system 170 prompts the communicating user at step 520 to select a communication mode if the group members can be contacted using different modes of communication.

At step 525, the system ensures that an address is available for each member of the group in the selected mode of communication. Addresses may be unavailable, for example, if the group information was not complete when set up for one or more of the communication modes. If so, system 170 gets any needed addresses at step 530 by prompting the user or by accessing some other available source (e.g., a global address directory). Upon receiving an instruction from the communicating user to begin the sequenced connections to group members, system 170 then attempts to connect the communicating user to the first user in the group at step 535. If system 170 determines at step 540 that there is an answer or connection, the system at step 545 waits for the connection to be terminated by the communicating user or the recipient group member. Once terminated, an appropriate announcement is played or displayed by system 170 at step 550, and the communicating user is prompted to proceed to the next sequence connection. If there is no answer (i.e., no connection) as determined at step 540, an appropriate announcement is also played or displayed to the communicating user and that user is prompted at step 550 to proceed to the next sequence connection.

Referring still to FIG. 5, at step 555 system 170 determines whether the communicating user terminated the sequential communication session (e.g., by selecting button 456 in FIG. 4) or the end of the group was reached. If not, system 170 gets the next sequence address in the group at step 560 and then connects to that sequence address at step 565. Steps 540, 545, and 550 then repeat in the manner described above. If the user ends the session or the end of the group is reached, an announcement is played/displayed at step 570 and the user may be prompted for further action before the sequential communication session ends at step 575.

Alternatively, instead of prompting the user at step 550 to proceed to the next group member communication in a group, system 170 may automatically step to the next connection once it determines that the prior connection was terminated or a prior attempt to establish a connection was unsuccessful (e.g., because a telephone line was busy). In this embodiment, a communicating user may still stop the sequential communications at any time, and optionally a pause command may further be provided to allow the communicating user to temporarily halt the sequential communications and then resume where the communicating user left off.

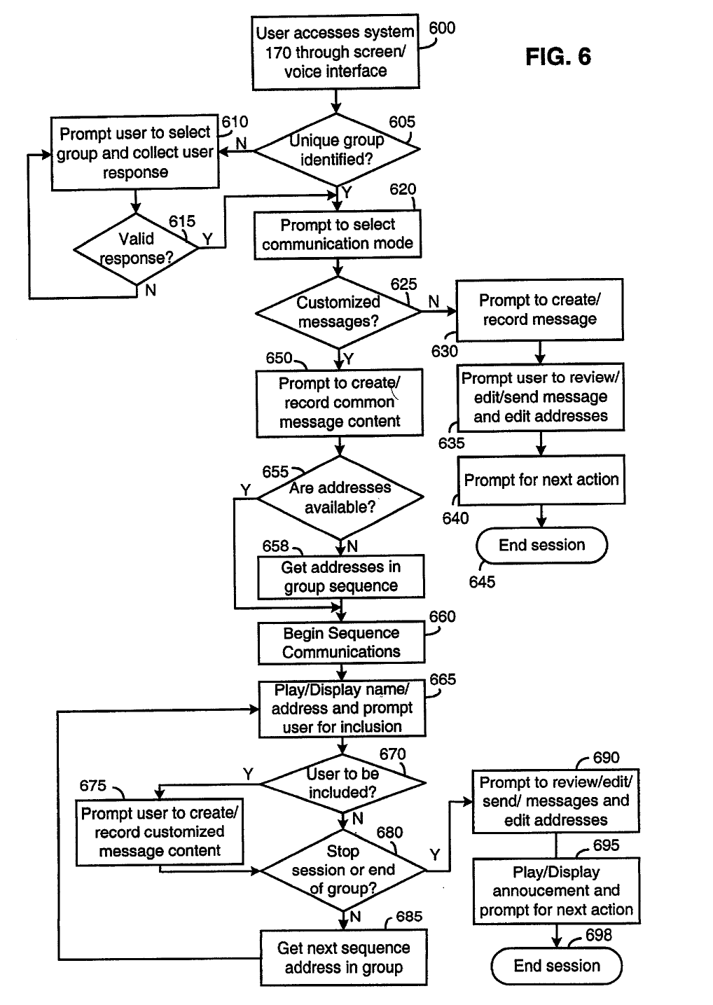

FIG. 6 is a flow chart illustrating a preferred method of operation of sequential communication system 170 in the case of non-real-time communications from a communicating user, such as e-mail or voice mail messages. As shown in FIG. 6, a communicating user accesses system 170 at step 600 through, for example, a screen or voice interface. At step 605, system 170 determines whether a unique group is identified, and, if not, system 170 prompts the communicating user at step 610 to select a group. If system 170 determines at step 615 that the communicating user's response is valid, the system ensures that a unique group has been specified. Otherwise, the user is re prompted to select a group up to some set limit of attempts. Once a unique group has been identified, system 170 prompts the communicating user at step 620 to select a communication mode if the group is set up so that members can be contacted using different modes of communication.

At step 625, system 170 determines whether the communicating user wishes to at least partly customize the content being delivered to group members or if each group member is to receive the same content. Preferably, the communicating user is prompted for this purpose. If the same content is to be communicated to each group member, then the user is prompted at step 630 to create or record the message content. Once the content is entered, the communicating user is subsequently prompted at step 635 to review or edit the message content or addresses before the content is sent to all group members. The user may then be prompted for further action at step 640, before the session ends at step 645.

Where the communicating user opts to customize at least part of the content for each group member, system 170 prompts the communicating user at step 650 to create or record any common content. For example, the communicating user may wish to send the same details of an upcoming meeting to each group member by email but may wish to customize the introduction and/or conclusion of each message for each group member. In this case, the details of the upcoming meeting may be conveniently recorded as common content in step 650. At step 655, the system ensures that an address is available for each member of the group in the selected mode of communication, and, if necessary, system 170 gets any needed addresses at step 658 by prompting the user (or by accessing some other available source).

Upon receiving an instruction from the communicating user to begin entering the sequenced message communications to group members, the sequenced communication session begins at step 660. In a preferred embodiment, at step 665 the name and/or address of the first member of the group is displayed to the communicating user who is prompted on whether that group member should be included in the sequence of telecommunication messages being sent by the communicating user. Alternatively, the communicating user may simply be provided with a skip option (e.g., button 454 in FIG. 4) so that a message to any desired group member can be skipped. If the first group member is to be included in the sequential messages, as determined at step 670, the communicating user is prompted at step 675 to create or record any customized message content that is then integrated with common content, if any, created or recorded in step 650.

If the first group member is not to be included in the sequential messages or once the message content has been created after step 675, system 170 determines at step 680 if the communicating user has stopped the entire sequential communication session (e.g., by selecting button 456 in FIG. 4) or if the end of the group has been reached. If not, system 170 gets the next sequence address in the group at step 685. Steps 665, 670, 675, and 680 then repeat for the next group member. If the communicating user ended the session or the end of the group was reached, the communicating user is prompted at step 690 to review or edit the message content or addresses for each message before sending the messages. Alternatively, each message may be reviewed and sent upon completion and before the creation of the next group member's message. At step 695, an announcement is played/displayed, and the communicating user may be prompted for further action before the sequential communication session ends at step 698.

Conveniently, system 170 allows a communicating user to quickly and effectively communicate with a desired group of users without having to repeatedly and separately initiate communication sessions with group members. Once a preceding communication has terminated, system 170 steps to the next communication in the sequence of separate communications either automatically or upon receiving a user instruction to continue. As a result, during the sequential communication session the communicating user does not have to enter new e-mail addresses, dial new numbers, or establish new messaging connections.

Thus, for example, a communicating user who wishes to telephone each member of a group may use system 170 to initiate a sequential communication session as described above, and thereby avoid having to separately initiate a telephone call by finding and dialing a telephone number for each group member. In this manner, the user can conveniently contact each group member without having to remember which communications within the group have been or have yet to be made and without having to remember or look up telephone numbers and/or speed dial locations. Similarly, a communicating user who wishes to send at least partly customized e-mail messages to each member of a group may use system 170 to initiate a sequential communication session as described above, and thereby avoid having to separately initiate each e-mail message by opening a “new message” window and entering or selecting an e-mail address for each group member. Again, while stepping through the communications, the communicating user does not need to remember which communications within the group have been or have yet to be made, and the user does not have to remember or look up e-mail addresses or nicknames.

Furthermore, as described above, a sequential communication user does not have to re-enter common content that is to be included in all customized messages to group members. As an additional feature, system 170 may maintain and display (or announce) status and progress information with respect to the sequential telecommunication connections and messages, providing a convenient record or reference with respect to those communications. If desired, status information from prior sequential communication sessions for that group may also be retained for reference purposes.

While the invention has been described in conjunction with specific embodiments, it is evident that numerous alternatives, modifications, and variations will be apparent to those skilled in the art in light of the foregoing description.

What is claimed is:

16. A method for facilitating sequenced communications to members of a defined group, the method comprising
providing a communicating user with a communication interface adapted to receive an instruction from the communicating user to initiate a single sequential communication session;
in response to the instruction, sequentially stepping the communicating user through separate communications to each of a plurality of members in the defined group, without the communicating user having to initiate separate communication sessions.

2. The method of claim 1 further comprising storing telecommunication address information relating to at least one telecommunication mode for each group member.

3. The method of claim 1 further comprising storing telecommunication address information relating to a plurality of telecommunication modes for each group member.

4. The method of claim 3 further comprising providing the communicating user with an ability to select the telecommunication mode for the sequential communication session.

5. The method of claim 1 further comprising providing the interface on a screen of a device of the communicating user.

6. The method of claim 5 comprising displaying an icon on the screen of the device to permit the communicating user to initiate the sequential communication session.

7. The method of claim 1 further comprising providing an audio-based interface and permitting the communicating user to initiate the sequential communication session using an audio command.

8. The method of claim 1 further comprising providing the communicating user with an ability to enter an instruction to proceed to a next communication in the sequential communication session.

9. The method of claim 1 further comprising automatically proceeding to a next communication in the sequential communication session once a prior communication in the session has terminated.

10. The method of claim 1 further comprising providing the communicating user with ability to enter an instruction to skip a next communication in the sequential communication session.

11. The method of claim 1 wherein the separate communications are made in real-time.

12. The method of claim 11 wherein the telecommunication mode is a telephone call or an instant message.

13. The method of claim 1 wherein the separate communications are not made in real-time.

14. The method of claim 13 wherein the telecommunication mode is an e-mail message or voice-mail message.

15. The method of claim 13 further comprising providing the communicating user with an ability to create common content for inclusion in each of the separate communications.
